(19) United States
(12) Patent Application Publication
(10) Pub. No.: US 2007/0113451 A1
(43) Pub. Date: May 24, 2007

(54) Collectible holders

(76) Inventors: John C. McDowell, Atlanta, GA (US); Roger K. Nix, Woodstock, GA (US); Jeffrey D. Mullen, New York, NY (US)

Correspondence Address: FISH & NEAVE IP GROUP;ROPES & GRAY LLP, 1211 AVENUE OF THE AMERICAS, NEW YORK, NY, 10036-8704, US

(21) Appl. No.: 11/479,309

(22) Filed: Jun. 30, 2006

Related U.S. Application Data
(60) Provisional application No. 60/696,056, filed on Jul. 1, 2005.
(60) Provisional application No. 60/756,276, filed on Jan. 4, 2006.
(60) Provisional application No. 60/696,059, filed on Jul. 1, 2005.

(51) Int. Cl. G09F 3/18

(52) U.S. Cl. 40/642.02

(57) ABSTRACT

A collectible holder is provided. More particularly, a collectible holder is provided that is fabricated from three portions—a sleeve portion, an insert portion, and a collectible receivable portion. The collectible receivable portion is insertable into, and removable from, an aperture located in the insert portion. The insert portion is inserted into the sleeve portion and sonically bonded. A Radio Frequency IDentification (RFID) tag is also provided in the collectible holder to store information associated with the stored collectible. As multiple RFIDs can be read simultaneously, numerous features are provided. In one, a scanner is presented at the unloading dock of a convention. A dealer is provided with a time to go through the scanner. All of the dealer's collectibles are uploaded to a remote database, an online store is autonomously generated for the collectibles, and the inventory published to the internet as part of an online inventory of the entire convention.

### CROSS-REFERENCE TO RELATED APPLICATION

This application claims the benefit of U.S. Provisional Patent Application No. 60/696,056 filed on Jul. 1, 2005 and titled “Collectible Holders” (Docket No. COIN/001 PROV), Provisional Patent Application No. 60/756,276 filed on Jan. 4, 2006 and titled “Collectible Holders” (Docket No. COIN/001 PROV2) and Provisional Patent Application No. 60/696,059 filed on Jul. 1, 2005 and titled “Collectible Holders Having Radio Frequency Identification Tags And Systems And Methods For Using The Same” (Docket No. COIN/002), which are hereby incorporated by reference herein in their entirety.

### BACKGROUND OF THE INVENTION

Sportscards have been encapsulated by Professional Sports Authenticators (PSA) and coins have been encapsulated by Professional Coin Grading Service (PCGS), both of which are divisions of Collectors Universe of Newport Beach, Calif. Collectors Universe encapsulates sportscards and coins by sonically bonding two slab portions to form a slab. One slab portion is laid on top of another slab portion with the sportscard (or coin), a label, and a two-dimensional hologram being sandwiched in the middle. The label contains text in the form of the name of the sportscard (or coin) and the grade that the sportscard (or coin) received from Collector's Universe. For sportscards, this grade is a whole number between, and including, 1 and 10.

The Collectors Universe slabs are deficient in a variety of ways. For example, only a minimal amount of information is provided on the label. Additionally, as a result of the slabs simply being laid one on top of another, the structural integrity of the holder is compromised.

Moreover, the security features associated with the slabs are inadequate. For example, PSA fixes a two-dimensional hologram to the label. The label and hologram are loose inside of the slab—even after the slap portions are sonically bonded together. Thus, a person may purchase a PSA 10 1952 Topps Mickey Mantle Card for $250,000, break the card and label out of the slab, fabricate his/her own slab, and encapsulate a lesser conditioned 1952 Topps Mickey Mantle Card (e.g., a 1952 Topps Mickey Mantle Card broken out of a PSA 8 slab that cost $45,000) into the new slab with the loose label and two-dimensional hologram. The person can then send the 1952 Topps Mickey Mantle from the PSA 10 holder to PSA and have it graded and returned in a brand new PSA 10 holder. The process can be repeated infinitely—each time netting the counterfeiter a substantial profit (e.g., over $200,000).

It is therefore desirable to fabricate a collectible holder that is structurally sound, allows for enhanced information storing capabilities, and includes numerous security features to prevent counterfeiting.

### SUMMARY OF THE INVENTION

It is an object of the present invention to provide a collectible holder that is structurally sound, allows for enhanced information storing capabilities, and includes numerous security features to prevent counterfeiting.

A collectible coin holder is provided that may be configured to encapsulate a variety of collectibles such as, for example, one or more coins, stamps, currency, sportscards, autographs, photographs, books, manuscripts, sportscard wax packs, sportscard wrappers, sportscard boxes, books, or comic books. One such holder is fabricated from two holder portions. One holder portion acts as a sleeve that the other holder portion slides into. The two portions are then bonded together (e.g., ultrasonically or thermally) to provide a structurally sound holder that permanently encapsulates a collectible.

The insert portion that slides into the sleeve portion may have a trough, or opening, that is operable to receive a third holder portion (e.g., a collectible receivable portion). This third holder portion may be configured to hold any particular type of collectible (e.g., coins of various sizes, stamps, or sportscards). Thus, two of the three holder portions (e.g., a sleeve and insert portion) may be the same regardless of the type of collectible that is stored (e.g., regardless of the configuration of a collectible receivable portion).

The holder portion that acts as a sleeve may have a ridge protruding from an exterior surface. In this manner, a trough may be cut into an opposite exterior surface, and aligned with the ridge protruding from the other side, such that such that multiple holders can be stacked together.

In some embodiments, a Radio Frequency IDentification (RFID) tag is encapsulated in the holder with the collectible. The RFID tag includes information regarding the particular collectible. Moreover, the RFID tag includes an RFID identification number that increases security. A label and three-dimensional hologram is also provided and may be fixed directly to either of the slab portions. The label and/or RFID tag may be fixed to be self-destructing such that removal from a holder portion causes the RFID tag, label, and/or hologram to break into one or more pieces.

The labels may also have a color that is associated to a type of collectible (e.g., stamps may have red labels while coins have blue labels or cleaned coins or replica/altered cards may have red labels while original, unaltered coins/cards may have blue labels). Similarly, a portion of the holder may also be tinted a particular color, where the color is associated to a type of collectible.

The label may include a bar code. Such a bar code may be fixed to the front of the insert portion. By curving the top of the sleeve portion, such a bar code may also be scanned from above when the holder is standing vertically (as well as being scanned vertically).

A display (e.g., an LCD) may also be placed in the holder. Such a display may be coupled to, for example, a memory or RFID (e.g., via a processor or other circuitry) such that information stored on such an RFID or memory may be displayed to a user. If the RFID can be written to, the information stored on the RFID may be updated (e.g., the number of a particular coin in a particular grade may be updated).

### BRIEF DESCRIPTION OF THE DRAWINGS

The above and other objects and advantages of the present invention will be apparent upon consideration of the following detailed description, taken in conjunction with accompanying drawings, in which like reference characters refer to like parts throughout, and in which:

FIG. 1 is an illustration of a collectible holder constructed in accordance with the principles of the present invention;

FIG. 2 is an illustration of a collectible holder with an RFID constructed in accordance with the principles of the present invention;

FIG. 3 is an illustration of a collectible holder with improved label visibility constructed in accordance with the principles of the present invention;

FIG. 4 is an illustration of a collectible holder with a self-destructing label constructed in accordance with the principles of the present invention;

FIG. 5 is an illustration of a collectible holder constructed in accordance with the principles of the present invention;

FIG. 6 is an illustration of a collectible holder constructed in accordance with the principles of the present invention;

FIG. 7 is an illustration of a collection holder constructed in accordance with the principles of the present invention;

FIG. 8 is an illustration of two stacked collectible holders constructed in accordance with the principles of the present invention;

FIG. 9 is an illustration of multiple holder portions configured to receive RFID tags constructed in accordance with the principles of the present invention;

FIG. 10 is an illustration of multiple holder portions configured to receive collectibles constructed in accordance with the principles of the present invention;

FIG. 11 is an illustration of a collectible holder with additional holder portion constructed in accordance with the principles of the present invention;

FIG. 12 is an illustration of multiple label configurations constructed in accordance with the principles of the present invention;

FIG. 13 is an illustration of a collectible holder with add-on sub-holder constructed in accordance with the principles of the present invention;

FIG. 14 is an illustration of hardware and external components constructed in accordance with the principles of the present invention;

FIG. 15 is an illustration of accessories constructed in accordance with the principles of the present invention;

FIGS. 16-19 are illustrations of a slab constructed in accordance with the principles of the present invention; and

FIGS. 20-23 are illustrations of a slab constructed in accordance with the principles of the present invention.

### DETAILED DESCRIPTION OF THE INVENTION

U.S. patent application Ser. No. ______ filed on Jun. 30, 2006 and titled “Collectible Holders Having Radio Frequency Identification Tags And Systems And Methods For Using The Same” (Docket No. COIN/002), U.S. patent application Ser. No. ______ filed on Jun. 30, 2006 and titled “Holder For Collectibles” (Docket No. COIN/003A), U.S. patent application Ser. No. ______ filed on Jun. 30, 2006 and titled “Holder For Collectibles” (Docket No. COIN/003B), and U.S. patent application Ser. No. ______ filed on Jun. 30, 2006 and titled “Holder For Collectibles” (Docket No. COIN/003C) are hereby incorporated by reference herein in their entirety.

U.S. patent application Ser. No. 10/888,601 filed on Jul. 8, 2004 and entitled “Systems and Methods for Providing Information For Collectibles” (Attorney Docket No. AND/001) is hereby incorporated by reference herein in its entirety. U.S. Provisional Patent Application No. 60/485,832 filed on Jul. 8, 2003 and titled “Systems and Methods for Providing Coin Information” (Attorney Docket No. AND/001 PROV) is hereby incorporated by reference herein in its entirety.

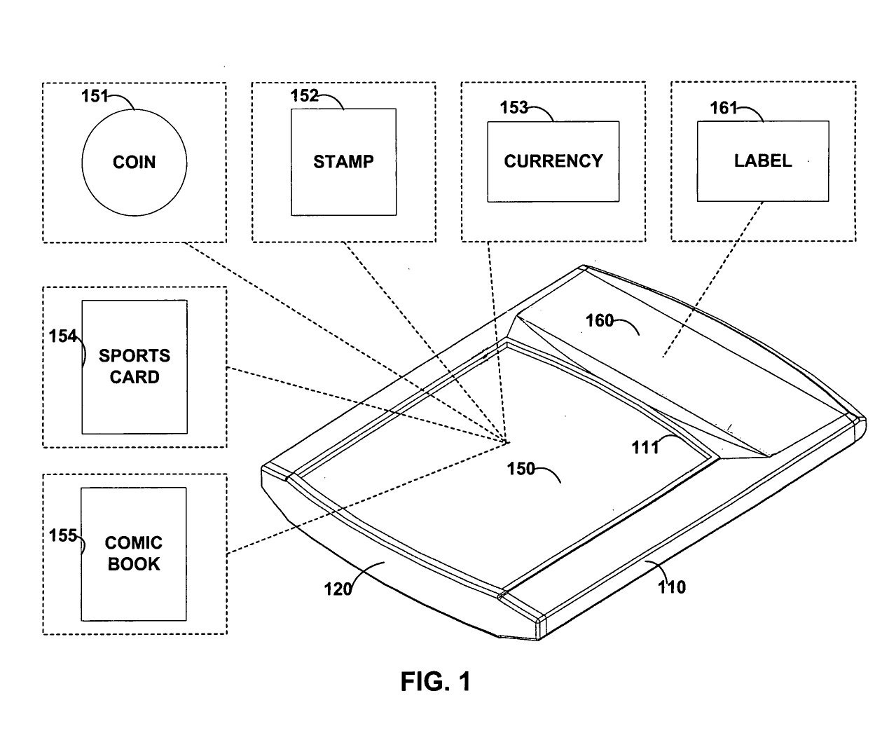

FIG. 1 shows holder 100 in which comic book 155, sportscard 154, coin 151, stamp 152, currency 153, or any other type of collectible or object can be encapsulated. Particularly, holder 100 includes holder portion 110, holder portion 120, and trough 111.

Holder portions 110 and 120 may be encapsulated by, for example, a thermal or sonic bonding process. Accordingly, holder portions 110 and 120 may be fabricated from a polymer, such as a transparent plastic or acrylic. Persons skilled in the art will appreciate that sonically bonding holder portions 120 and 110 together may provide a relatively strong bond such that to open the holder, the portions may need to be broken. Thus, sonic bonding provides a holder that can not be reused after the holder opened. In this manner, sonic bonding provides a high level of security so that the owner of the encapsulated collectible is protected from counterfeits.

Portions 110 and 120 may also be removably attached together. For example, portion 110 may snap to, or screw into, portion 120. In doing so, a reusable collectible housing is provided in which multiple types of collectibles and other objects (e.g., RFIDS) may be safely stored.

Portion 120 may be a cap for sleeve portion 110 such that portion 120 does not substantially extend into sleeve portion 110 when bonded with portion 120. Alternatively, portion 120 may be an insert portion such that a substantial portion of portion 120 extends into sleeve portion 110 when bonded with portion 120.

Portions 110 and 120 may be completely, or partially, transparent. For example, only portion 150 (the face of portion 110 defined by trough 111) may be transparent. Accordingly, holder 100 may be configured such that any collectible stored in holder 100 aligns with portion 150 such that the collectible is visible through the holder. Label 161 may similarly be encapsulated around location 160.

Similarly, portions of holder 100 may not be transparent. An RFID, for example, may be encapsulated around location 160. This portion of holder 100 may be non-transparent such that, for example, a user has to break open holder 100 in order to determine the type of RFID (or component) that is housed in holder 100. Thus, non-transparent portions may provide for a holder with added security.

Trough 111 may be provided to, for example, provide a stacking functionality in holder 100. Persons skilled in the art will appreciate that trough 111 may generally be a intrusion into holder 100. Such an intrusion may, for example, be the size of portion 150. In such a case, the surface of portion 150 is protected from scratching as it is located in trough 111. Trough 111 may be provided on the obverse or reverse side of holder 110.

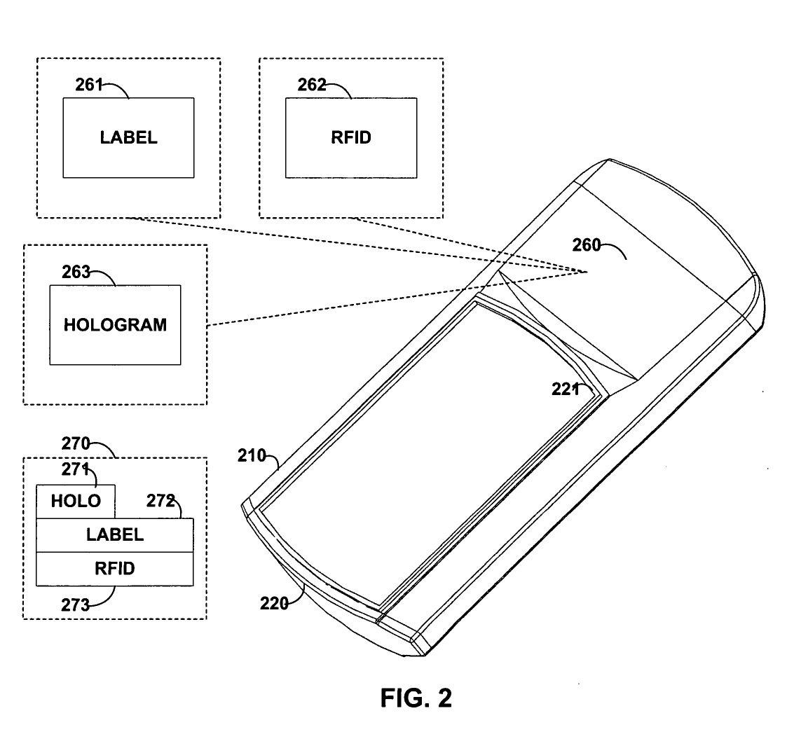

FIG. 2 shows holder 200 that includes protruding ridge 221, holder portion 210, and holder portion 220. RFID 262, label 261, and hologram 263 may be encapsulated in holder 200.

RFID 262, label 261, and hologram 263 may be fixed together in a number of various configurations as well as being fixed to any portion of holder 200 (e.g., a sleeve portion, insert portion, or collectible receivable portion). For example, hologram 271 may be glued to a portion of the surface of label 272. Label 272 may, in turn, be glued to a portion of the surface of RFID 273. Similarly, holo 271, label 272, or RFID 273 may be fixed (e.g., glued) to a portion of holder 200. Persons skilled in the art will appreciate that affixing such components together (or to a portion of holder 200) may decrease the possibility of counterfeiting. For example, when a holder is broken, a hologram attached to a portion of the holder may not be removed and used in a counterfeit holder.

Ridge 221 is preferably located on the exterior surface of portion 210 that is opposite that of an associated trough (e.g., trough 111 of portion 110 of FIG. 1). As a result, ridge 221 can mate with a trough on a similar holder such that the two holders may be stacked. Ridge 221 also acts as a protective structure (similar to a trough) to prevent objects from coming into contact with the portion of holder 200 defined by ridge 210. Thus, ridge 221 decreases scratching to the portions of holder 200 that may align with an encapsulated collectible.

Generally, RFID 262 may be included in holder 200 in order to store information about the collectible protected by holder 200 and transmit this information wirelessly to a receiver. Doing so, provides the ability for numerous advantageous systems and functuality.

For example, a scanning gateway can be provided at the entrance to a convention. Dealers may be allotted particular times to use the entrance to unload collectibles into the convention. The scanner can be coupled to a computer. Thus, every collectible included in an RFID-enabled holder (e.g., holder 200 of FIG. 2) can be read by the scanner/receiver and stored in the computer. As such, the collectible information may be utilized to generate an online store for the dealer. The dealer can then log into this online store and enter in pricing information for each collectible. The store can immediately publish to a webpage such that people not at the convention can buy collectibles at the convention. As such, a virtual convention is provided that mimics the actual convention. As collectibles are sold, the dealer can update the webstore.

The addition of an RFID to a collectible holder also provides enhanced security. For one, counterfeiters may have a harder time counterfeiting RFIDs than traditional labels. Moreover, each RFID can include an encrypted identification number that is unknown to anyone other than the entity that originally encoded the RFID. As per another example, RFID scanners/receivers can be placed at the exits of conventions and/or stores. Those collectibles that were not purchased (e.g., RFID-enabled holders that are still on a dealer's online store) can thus be detected and, for example, used to set of an alarm or alert security.

Persons skilled in the art will appreciate that holder 200 may include a memory device, power source, transmitter, and other circuitry in order to store and transmit data about a collectible. Additionally, collectible holder 200 may include a receiver such that, for example, data may be written to memory stored in holder 200 (e.g., such that pricing information may be uploaded to a holder). Additionally, RFID circuitry may be printed, by an RFID printer, on a label the same time text (e.g., a bar code) is being printed on that same label.

Data about a collectible may include, for example, the collectible's name (e.g., 1884 Morgan Silver Dollar—$1), the collectible's grade (e.g., MS68), the grading company (e.g., ANACS), the date the coin was graded (e.g., Jan. 1, 2005), any type of additional information about the collectible (e.g., the original mintage or print run), the number of collectibles of that same type graded to date (e.g., 103), the number of type of collectibles of that same type graded that same grade (e.g., 10), the specific identification number by the grading company for the collectible (e.g., 345981112), additional specific information by the grading company (e.g., internal category number associated to type of collectible such as 6907.68), and any other type of information. Such additional information may include, for example, information that may not be able to be printed on a label because of size concerns. Thus, such information may include an extensive history of the collectible, populations for the collectible in a variety of grades, historic pricing information for the collectible in a variety of grades, information about the encapsulation authority (e.g., ANACS contact information), and information about the components of the holder (e.g., information about RFID such as type and version).

Holder 200 may be utilized by a variety of entities in addition to grading entities. For example, authenticating entities may utilize holder 200 to store a collectible after the collectible has been determined to be authentic (e.g., after an autograph on an index card has been authenticated). Store owners and dealers may also utilize holder 200 to, for example, encapsulate their collectible products to reduce theft and increase the amount of information displayed to a potential buyer for a collectible.

Collectors may also utilize holder 200 to protect a collectible as well as store additional information about a collectible that can be wirelessly transmitted. As such, RFID readers and encoders can be distributed to collectors. For example, a kit may be fabricated that includes a reader/encoder, a number of RFID tags (e.g., 100), a number of holders 200 (e.g., 25), and software such that the collector may be provided with a Graphical User Interface (GUI) to enter in and modify information for encoding.

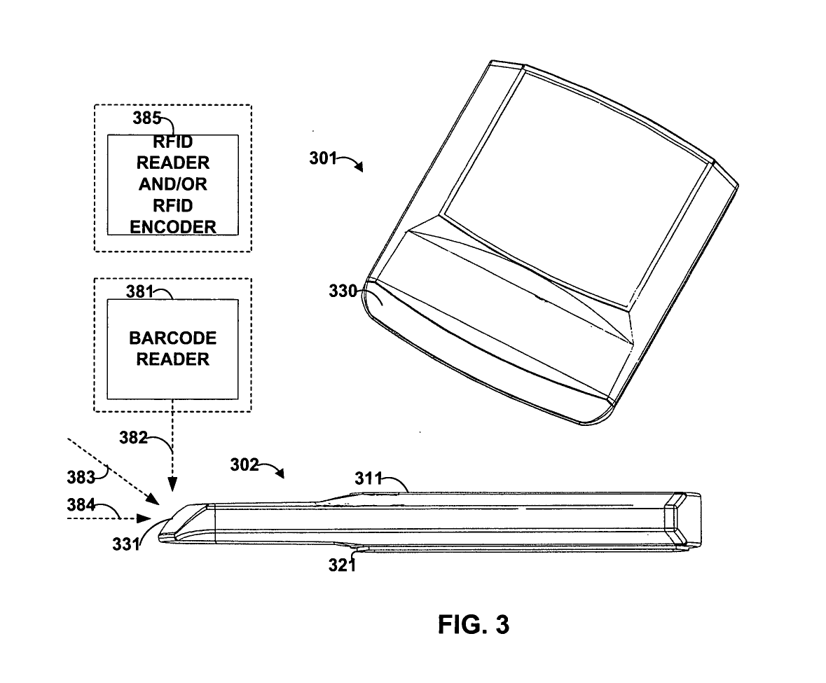

FIG. 3 shows holder perspectives 300. Particularly, FIG. 3 shows holder perspectives 301 and 302 that includes curved slab portions 330 and 331, respectively. Slab portions 330 and 331 are curved such that, for example, a label may be scanned by barcode reader 381 from multiple directions (e.g., directions 382, 383, and 384). As a result, multiple holders having curved slab portions may be stacked and the bar code can be read while the holder is stacked. Thus, only a single label is needed to display information. Persons skilled in the art will appreciate that an insert portion of a holder may be curved similar to the curve of the sleeve portion of a holder such that the label is curved when fixed to the insert (or sleeve) portion. As labels may include RFIDs (or other circuitry), RFID reader and/or encoder 385 is provided.

Holder 300 may be stacked, for example, as a result of the structural attributes of the exterior sleeve. For example, trough 311 may be provided to mate with a structure similar to ridge 321. Persons skilled in the art will appreciate that ridge 321 may include numerous segments of ridges. Similarly trough 311 may include numerous segments of troughs.

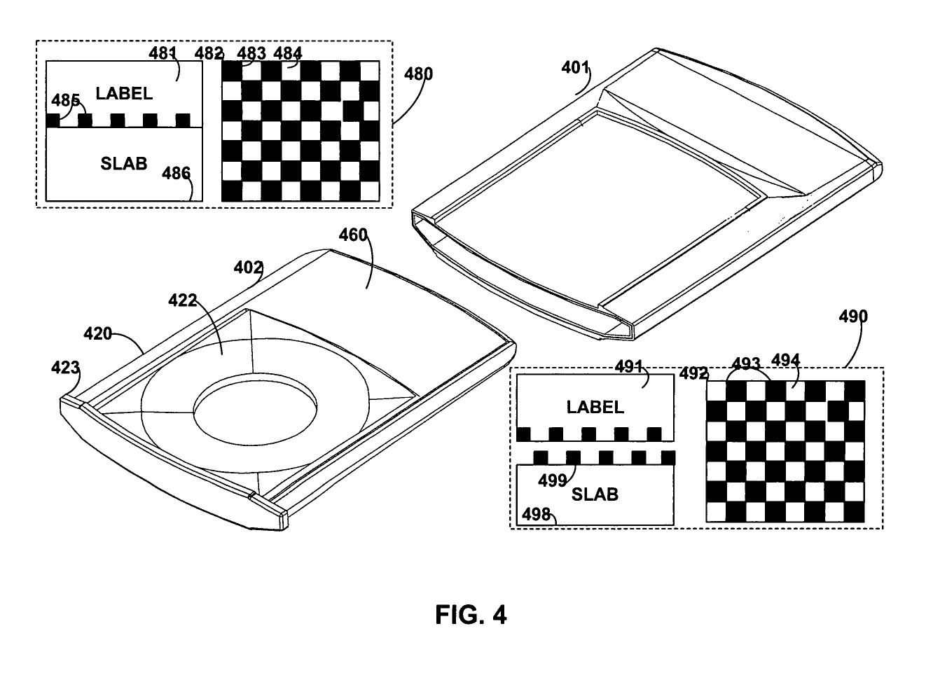

FIG. 4 shows holder 400 that includes insert portion 402 and sleeve portion 401. Insert portion 402 is configured to receive a collectible into collectible receivable portion 422. After a collectible is received, insert portion 402 is inserted into, and bonded to, sleeve portion 401. Persons skilled in the art will appreciate that if portion 401 and 402 are fabricated from, for example, a hard acrylic that sleeve portions 402 and 401 can be coupled together by ultrasonic bonding. Such bonding can be provided in a number of areas—such as where portion 423 meets sleeve portion 401.

A label and/or RFID may be fixed to insert portion 460 (or a portion of exterior sleeve 401 that aligns with portion 460). Such labels and/or RFIDs may be self-destructive such that the labels and/or RFIDS break apart when removed from a holder portion. A self-destructive label and/or RFID may be provided in a variety of ways. For example, label 481 may be adhered to slab 486 at portions 485 as shown in configuration 485. The adhesive may be, for example, a glue that bonds label 481 to 486 such that when label 481 is removed, the portions of label 485 aligned with adhesive portions 485 stay fixed to slab 486. Such adhesive portions may cover the label in, for example, a checkerboard type configuration as shown in label 482 that includes non-adhesive portion 484 and adhesive portion 483). Similarly, the adhesive can be included in a variety of shapes such as, for example, a company logo. Multiple adhesives may be used on a single label having multiple bonding strengths.

Label configuration 490 shows label 491 fixed to slab 498. Here, the slab has adhesive portions (e.g., portions 499) that are staggered with the adhesive portions of the label. For example, label 491 may have an adhesive pattern similar to the pattern of portions 493 of surface 492, while slab 491 may have an adhesive pattern similar to the pattern of portions 494 of surface 492. Such a configuration may increase the amount that a label (or RFID) breaks when removed from a slab (or other component). Alternatively, label 491 may have two (or more) adhesive patterns—each one having a different bonding strength. For example, label 491 may have an adhesive with one bonding strength at portions 493 and a second adhesive with a second bonding strength at portions 494.

Persons skilled in the art will appreciate that the adhesive patterns of configurations 480 and 490 may also be utilized for a hologram. Such a hologram may be, for example, a two or three dimensional hologram of a company logo.

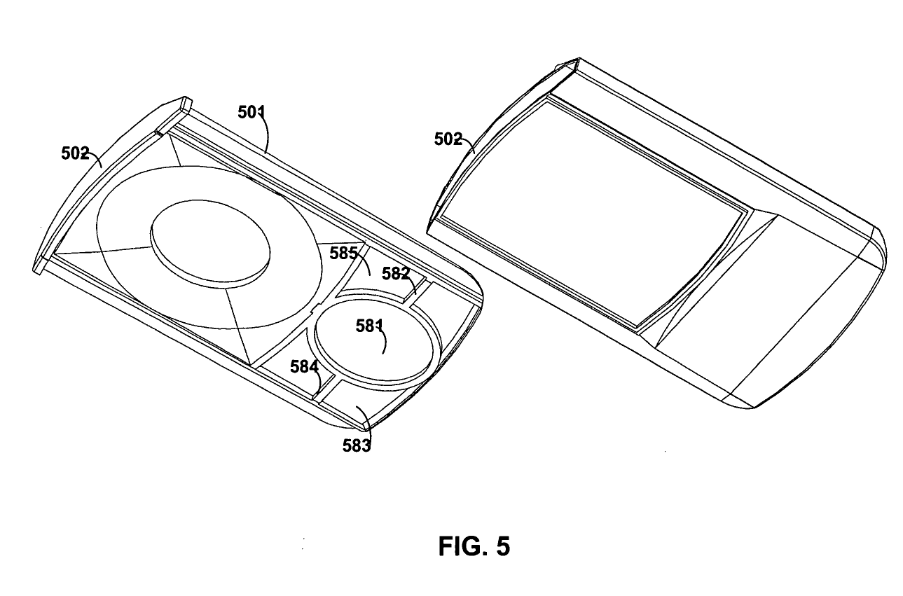

FIG. 5 shows holder 500 that includes insert portion 501 and sleeve portion 502. When insert portion 501 is placed in sleeve portion 502, insert portion 501 is surrounded by sleeve portion 502 on all sides except for one surface (e.g., surface 510).

A portion of insert portion 501 may be sculpted to fit an RFID chip or other circuitry (e.g., portion 581). Such a portion may be, for example, as deep as an RFID chip is tall (or other circuitry). Such Sculpting may be provided by providing a frame to define portion 581 (and include structural support frames 582 and 584). In providing a frame, the thickness of insert slab 501 in the proximity of portion 581 may be thinned—thus cutting down costs. Alternatively, a frame may not be provided (e.g., sections defining the frame, such as sections 583 and 585, may be filled with the material used to fabricate insert portion 501).

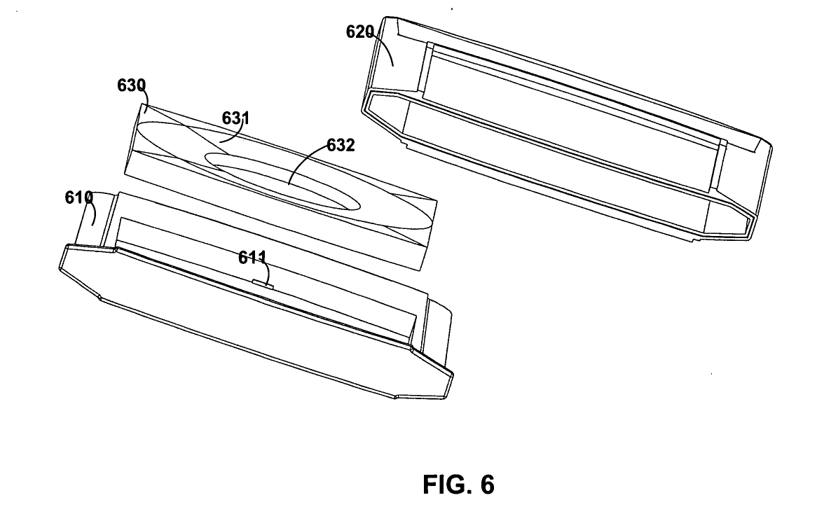

FIG. 6 shows holder 600 that includes insert portion 610 that can be inserted into sleeve portion 620. Insert portion 610 can include an aperture (or trough) for receiving a collectible receivable portion 630. Collectible receivable portion 630 may have a variety of apertures (or troughs) of varying shapes depending on the type of collectible that collectible receivable portion 630 is operable to receive. Thus, for example, collectible receivable portion 630 may include aperture 632 of one diameter for a coin of one size (e.g., a dime) while a different receivable portion 630 includes an aperture having a different diameter for a coin of a different size (e.g., a quarter). As a result, multiple types of collectibles can be stored in holder 600 (e.g., basketball cards, coins, without having to change the molds for outer sleeve 620 or insert sleeve 610).

Persons skilled in the art will appreciate that the depth of aperture 332 may be less than the height of collectible receivable portion 630. Particularly, collectible receivable portion 630 may slope down towards aperture 322. Doing so may, for example, allow for a collectible to be stored without the risk of having the surface of that collectible touch the surface of sleeve portion 620. Coin receivable portion 630 may be transparent such that, for example, the sides of a collectible may be viewed (e.g., the edge/side of a coin).

Collectible receivable portion 330 and/or insert portion 610 may include structures to connect collectible receivable portion 330 and insert portion 610 together. For example, one or more ridges 611 may be provided in either portion. Holes to receive such ridges may also be provided.

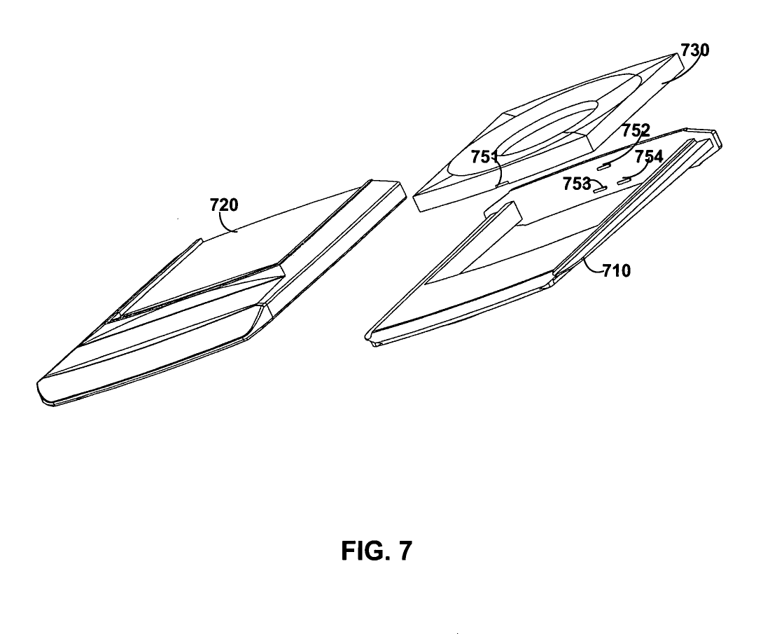

FIG. 7 shows holder 700 that includes insert portion 710, sleeve portion 720, and collectible receivable portion 730. Collectible receivable portion 730 may include, for example, hole 751 to mechanically couple with, for example, a ridge on an insert portion (e.g., ridge 611 of FIG. 6). Collectible receivable portion 730 may include additional holes (or ridges) that may be used, for example, to mechanically couple to ridges 752, 753, and 754 of insert portion 710. Person skilled in the art will appreciate that ridges 752, 753, and 754 may be included and utilized to sandwich the end of a collectible receivable aperture—even those collectible receivable apertures without holes for coupling with ridges 752, 753, and 754. In this manner, ridges 752 may be spaced apart from ridges 753 and 754 at a distance approximately equal to the height of collectible receivable aperture 730.

Collectible receivable portion 730 may alternatively be provided as a separate portion of the holder, but insert portion 710 may be fabricated to include the structures provided in a collectible receivable portion (e.g., a collectible receivable aperture).

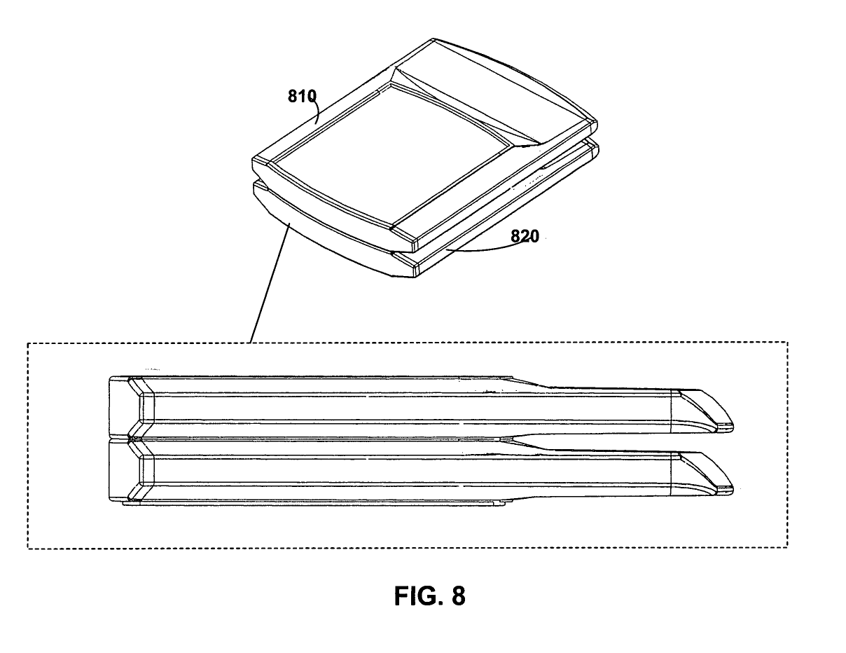

FIG. 8 shows stacking configuration 800 that includes holder 810 and 820.

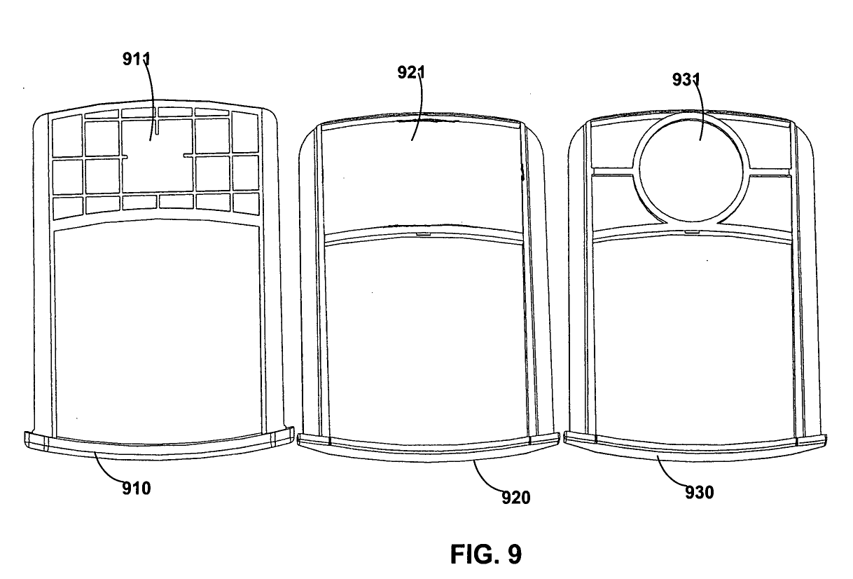

FIG. 9 shows insert portions 900 that includes insert portion 910, insert portion 920, and insert portion 930. Insert portions 910, 920, and 930 include additional component receivable portions 911, 921, and 931, respectively. The types of components that may be inserted into component receivable portions 911, 921, and 931 may include, for example, any number and any combination of RFID tags, compact flash, smart cards (e.g., the smart chips of smart cards), microprocessors, memory, circuitry, interconnect, input/output ports, displays, input controls, transmitters (e.g., wireless or non-wireless transmitters), and receivers (e.g., wireless or non-wireless receivers.

Insert portion 910 may include a square or rectangle-shaped component receivable portion. Insert portion 920 may include a component receivable portion sized to the perimeter of at least a portion of insert portion 920 (e.g., the area between a perimeter and the aperture defining a collectible receivable portion). Insert portion 930 includes a circular coin-receivable portion.

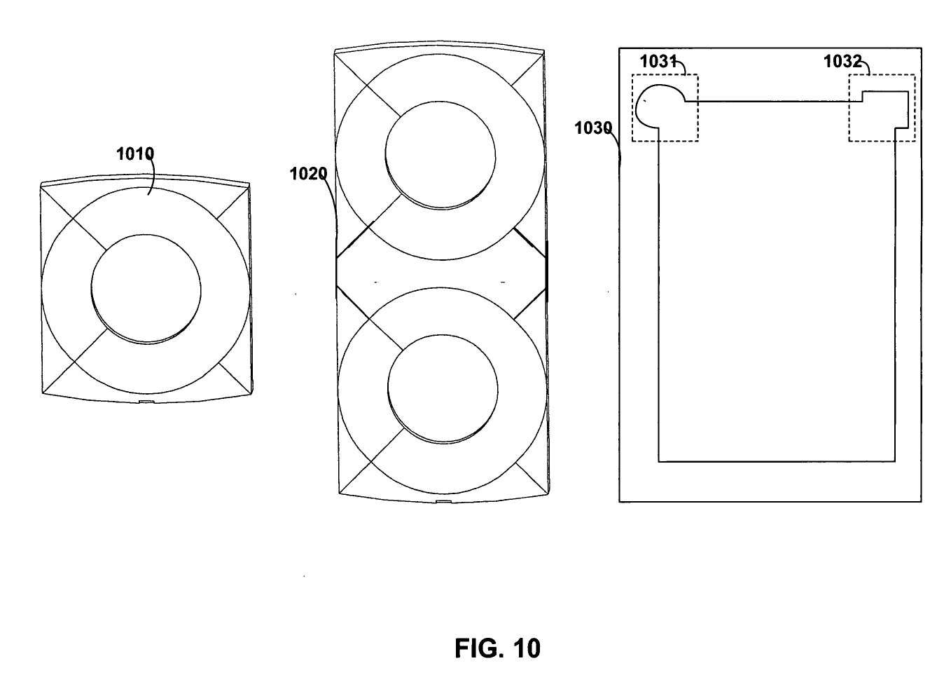

FIG. 10 shows collectible receivable portions 1000 that includes collectible receivable portion 1010, 1020, and 1030. Collectible receivable portion 1010 includes a coin-receivable aperture. Collectible receivable portion 1020 includes two collectible receivable apertures (e.g., two coin-receivable apertures). Collectible receivable portion 1030 includes a rectangular/square receivable aperture that may be utilized, for example, to store a sportscard, book, currency, postcard, comic book, or other rectangular/square object. As the corners of a rectangular/square object are sensitive, the area around these corners may be opened. As such, opened corner portions 1031 and 1032 are provided in circular and rectangular/square shapes, respectively.

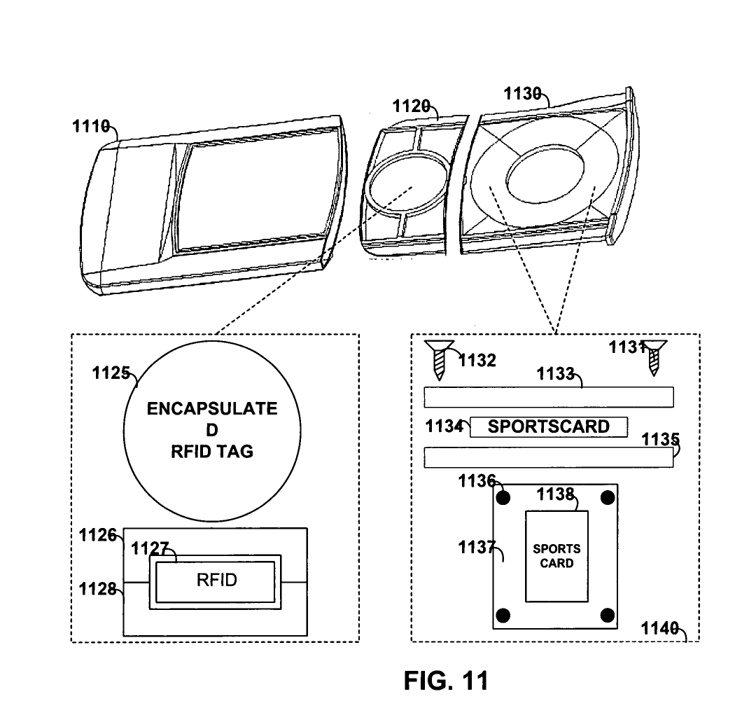

FIG. 11 shows holder 1100 that includes sleeve portion 1110, insert portion 1130 (having a collectible receivable portion), and additional component receivable portion 1120 that is separate from insert portion 1130. By having a separate collectible receivable portion 1130, the additional components may be updated without utilizing a different insert portion 1130. Additionally, if no additional components are needed, only the shortened insert portion 1130 can be used. Persons skilled in the art will appreciate that all of insert portion 1130 may be insertable into sleeve portion 1110. Accordingly, the portion of insert portion 1130 that stops against sleeve portion 1130 may be provided as a separate portion.

Persons skilled in the art will appreciate that circuitry may be harmful to collectibles. For example, RFIDs are fabricated using chlorine. Traces of such chlorine reside in each RFID. Thus, an RFID may be encapsulated in an air-tight material such that the chlorine will not be able to escape and damage a collectible (e.g., a coin). Particularly, RFID 1127 may be encapsulated in holder portions 1126 and 1126 to provide encapsulated RFID tag 1125.

The material of any of the components of holder 1100 may also be air-tight as well as protect against UV light. Mylar sheets, or any transparent polymer sheet, may be provided on both sides of a collectible in holder 1100 to further protect the collectible. Furthermore, mylar sheets, or any transparent polymer sheets, may be removable adhered to the exterior surfaces of sleeve portion 1110 such that a collector can replace a scratched sheet with an unscratched sheet without having to worry about scratching sleeve portion 1110.

Instead of including a collectible receivable portion having a collectible receivable aperture, two sheets of a material (e.g., rigid or soft plastic) may be utilized to sandwich a collectible. One such configuration is provided as configuration 1140. Here, sportscard 1138 is secured to holder 1137 by screws 1136. Particularly, one or more screws 1132 and 1131 may be utilized to secure sportscard 1134 (or any collectible) between sheets 1133 and 1135.

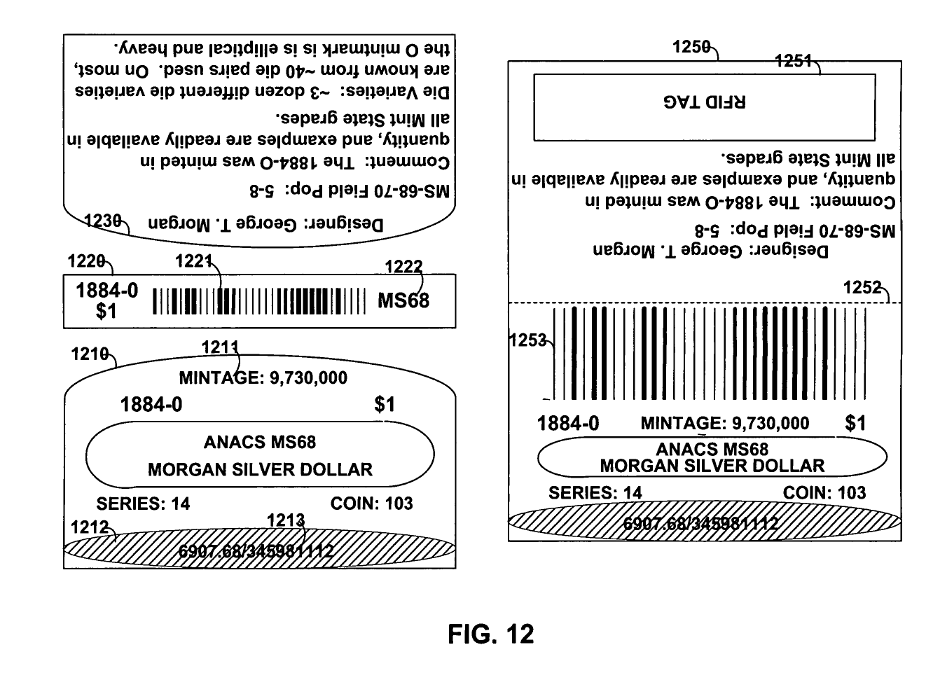

FIG. 12 shows label configurations 1200. In one label configuration, three separate labels are provided as labels 1230, 1220, and 1210. Labels 1230 and 1210 can be used on the obverse and reverse side of, for example, an insert portion or sleeve portion. Label 1220 can be used, for example, on the edge of an insert portion (or sleeve portion), such as the top edge of an insert portion to display information when holders are stacked. Such a label 1220 may be utilized, for example, if the top edge of a holder is not curved.

Numerous types of information may be provided on a label. Any type of information that is stored on an RFID, or a memory, may be printed on any label of configurations 1200. For example, bar code 1221 may be provided. Bar code 1221 may be representative of, for example, and of the information stored on an RFID, a memory, or a label. As such, bar code may be a number that is similar to an grading company's specific identification number for a collectible. The bar code could also be representative of the type of collectible (e.g., a Morgan silver dollar) and grade (e.g., ANACS MS68). Similarly, a label may include the year that a collectible was made as well as the production facility (e.g., in the case of a coin, the mint at which the coin was fabricated). Grading information 1222, mintage 1211, specific identification number 1213, and hologram 1212 may also be provided on a label.

Alternatively label 250 may also be utilized and, in some cases, wrapped around the top edge of a holder such that the label displays information on both the back and front of the holder (e.g., the front and back of an insert portion). Such a label may include an extended bar code 1253 such that if the top of a holder is curved, the bar code can be easily recognized from both head-on scans and scans from above. Label 250 may also be cut at line 1252 so that two labels are provided or folded around the top edge of an insert portion (or folded around the interior top edge of a sleeve portion) at line 1252. RFID tag 1251 may be fabricated and attached to a label (e.g., glued). Alternatively, RFID tag 1251 may be printed on, and with, label 1250.

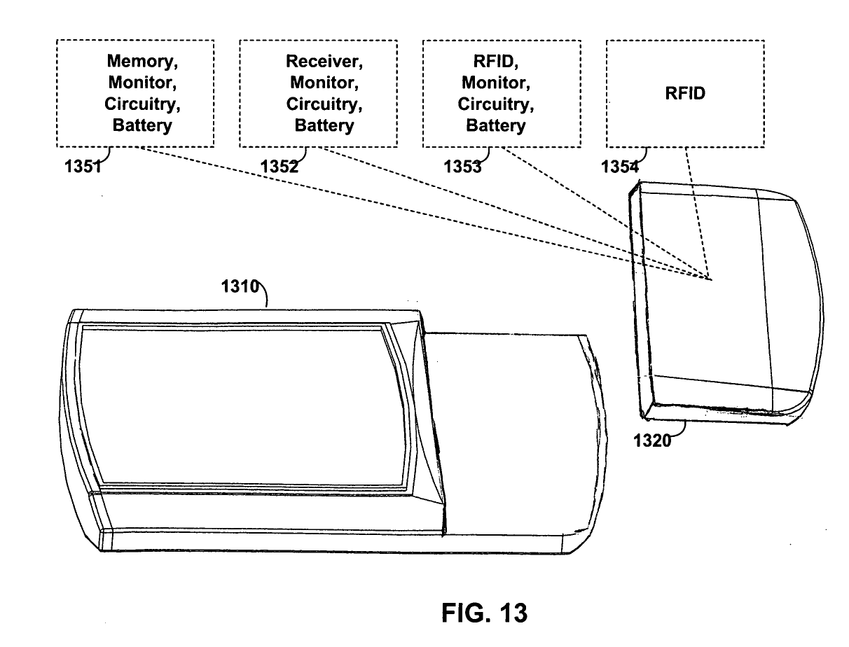

FIG. 13 shows holder 1300 that includes collectible holder 1310 that is operable to mechanically couple with component holder 1320. Particularly, the exterior of collectible holder 1310 is operable to mechanically couple with the exterior of component holder 1320. By including a component holder on the exterior of the collectible holder, updates (e.g., RFID updates) can be shipped to a collector and the collector can update the holder himself/herself without having to break open the collectible (and risk damage). Numbers can be printed on, or etched into, each of holders 1310 and 1320 to reduce the change of counterfeiting. For example, holders 1310 and 1320 can be printed with, or etched with, the same number. Person skilled in the art will appreciate that holder 1310 can also hold a component, such as an RFID. As a result, functionality can be added by the additional components without loosing the functionality of the components in holder 1310.

For example, holder 1310 may include a first generation RFID operable to hold one amount of information. Holder 1310 may include a second generation RFID operable to hold a second amount of information. The second RFID may be purchased, along with holder 1320 to users that want to store additional information. Or, the second RFID may be purchased for the ability to access the additional information stored in the RFID through for example, an LCD located in additional holder 1320 (or holder 1310). Electrical connection ports may be provided between holder 1310 and 1320 such that holder 1310 can communicate to holder 1320. As a result of an exterior holder, the functionality of holder 1310 is scalable and can be updated by anyone.

Holders 1320 and 1310 may be configured such that any mechanical coupling between the two is temporary such that holder 1320 can be removed with ease so that a new holder 1320 can be added. For example, holder 1310 may include rails and holder 1320 may include rail receiving structures such that holder 1320 can slide onto holder 1310. Alternatively, holder 1320 can be bonded (e.g., ultrasonically) to holder 1310).

Component holder 1320 can hold any type of holder and may include a sleeve portion, an insert portion, and a component receivable portion). For example, holder 1320 may include components 1354 (e.g., an RFID), components 1353 (e.g., an RFID, monitor, circuitry, and a battery), components 1352 (e.g., a receiver, monitor, circuitry, and battery), or components 1351 (e.g., a memory, monitor, circuitry, and battery). Any component that can be stored in holder 1320 can be stored in holder 1310. Any component that can be stored in holder 1310 can be stored in holder 1320.

Persons skilled in the art will appreciate that some of the functionalities and structures of this specification may be included in any type of holder. For example, an RFID may be provided in a holder that includes two portions that are laid on top of one another to form a space for storing a collectible. Such portions can each have a trough for receiving have a collectible such that when the two portions are fixed together, a space is available for storing the whole collectible.

Persons skilled in the art will also appreciate that holder 1300 may hold two or more RFID tags. For example, holder 1310 may be provided by one grading company and may include an RFID that stores information from that grading company for the collectible stored in holder 1310 (e.g., that grading companies' grades). The ability to receive additional holder portions, such as component-receivable portions, allows for the user to submit holder 1310 to a second entity, such as a second grading authority, and receive holder 1320 that includes a second RFID that stores information from that second company for the collectible stored in holder 1310 (e.g., the second companies' grades). Thus, holder 1300 allows for multiple companies to grade, or authenticate, a coin such that the coins condition, or authenticity, can be better established.

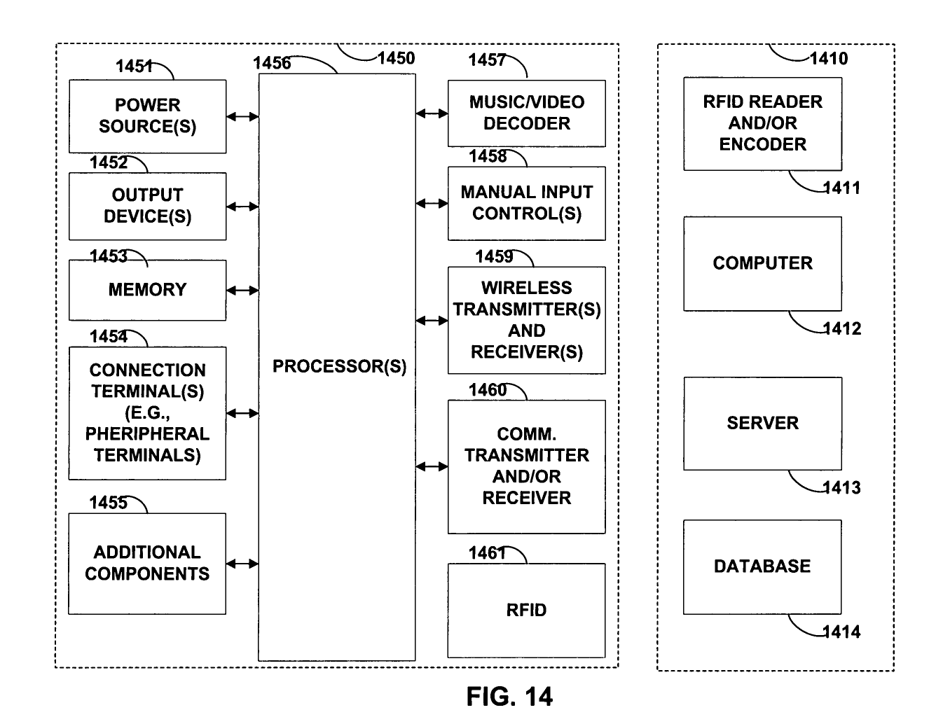

FIG. 14 shows hardware 1400 that includes holder components 1450 and external components 1410. Holder components may include, for example, any number of power sources 1451, output devices 1452, memory 1453, connection terminals 1454, processors 1456, music/video decoders 1457, manual input controls 1458, wireless transmitters/receivers 1459, RFIDs 1461, communication transmitters/receivers 1460, or any other additional component or software 1455.

Components 1456 may control, interact with, or be controlled by components 1410. Components 1410 may include, for example, RFID reader and/or encoder 1411, computer 1412, server 1413 (e.g., a web-server), and database 1414 (e.g., a database remove from computer 1412).

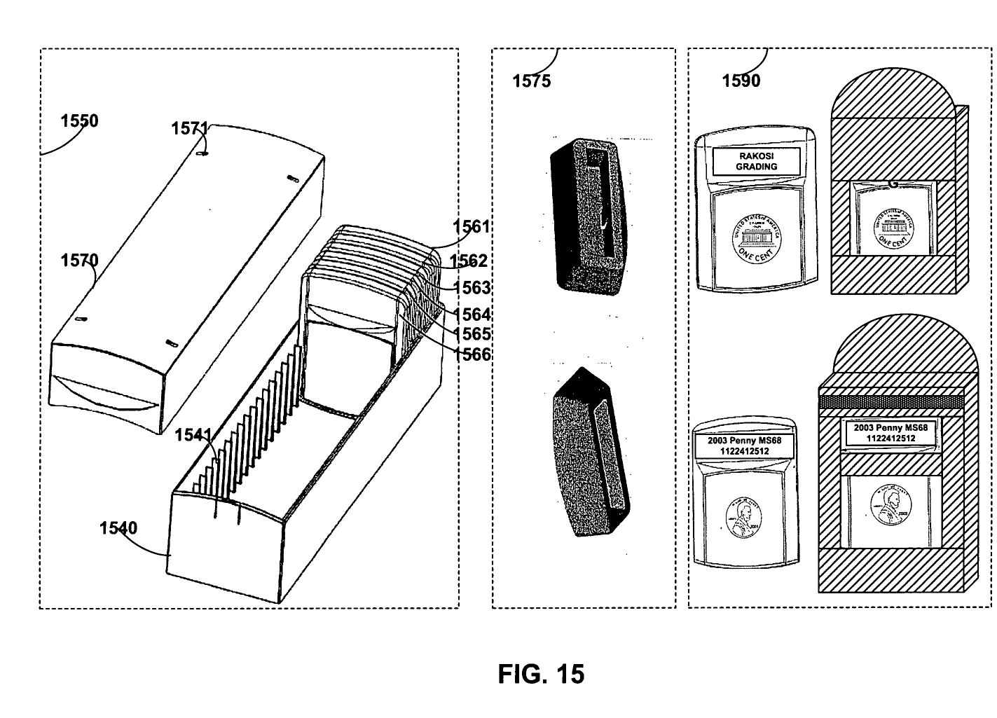

FIG. 15 shows accessories 1500 that includes holder rack 1550 and holder base 1575. Holder rack 1550 includes ridges 1541 that can be used to mechanically hold a holder in rack base 1540. As shown, holders 1561-1566 are held upright in rack base 1540 by multiple ridges. Ridges 1541 may be spaced apart, for example, at a distance approximately equivalent to the width of a holder. Rack base 1540 may fit with rack top 1570 (which also may include ridges similar to ridges 1541). Rack base 1540 may include feet (not shown) that may fit into holes 1571 of rack top 1570 such that multiple racks 1550 may be stacked. Persons skilled in the art will appreciate that due to the size of a collectible holder of the present invention (e.g., a coin holder), the number collectible holders that may fit into holder rack 1550 may be relatively large. For example, a rack that is approximately nine inches in length, three inches wide, and four inches tall may be operable to house twenty-five collectible holders (e.g., coin holders). This same rack may also be spaced such that the rack holds approximately twenty to twenty-five, for example, collectible holders (e.g., coin holders). Collectible holders that fit into this rack may be sized to be less than, for example, three inches in width and four inches in height, and less than approximately three-eighths of an inch thick (e.g., approximately 11/32nds of an inch or approximately 10/32nds of an inch). As such, a dealer may transport a large number of holders in a relatively small space. For example, suppose a dealer can carry two holder racks 550 while walking around a collectible show.

Holder base 1575 may be utilized to stand a single holder upright such that a single holder may be displayed to a user. Holder base 1575 may include a structure to snap onto, or provide force to, a holder. For example holder base 1575 may include a protruding structure that provides force against a collectible holder stored in holder base 1575 such that the collectible holder is forced against a side of collectible holder 1575.

Holder sleeves 1590 may be provided to protect a holder from, for example, scratching. Such holders may be fabricated from a material that will not scratch the material of the collectible holder. Such a material may be, for example, a velvet or mylar. Transparent windows may be provided in such holder sleeves such that the collectible (and label information) may be viewed when stored). Such windows may be provided by, for example, a transparent polymer such as mylar. Velcro, adhesive tape, or static-cling polymers can be provided such that the holder sleeves can be securely closed after a collectible holder is provided in a holder sleeve.

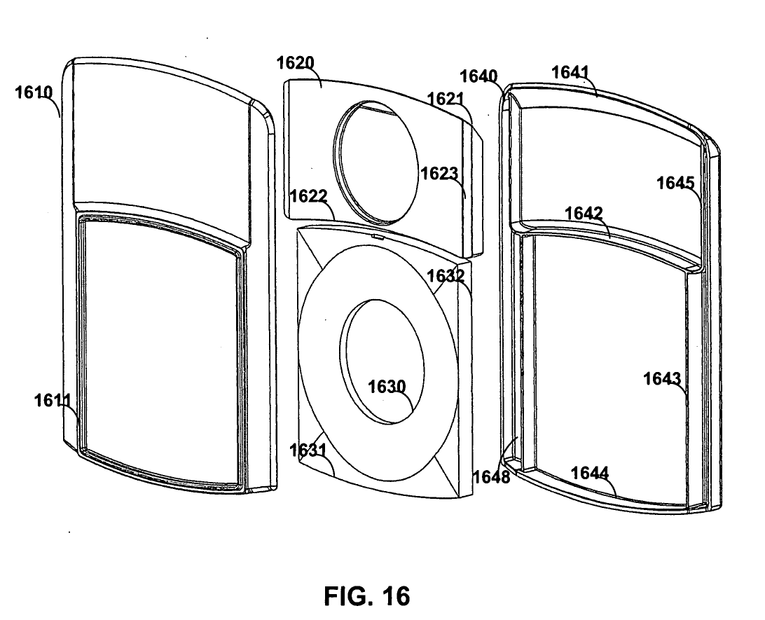

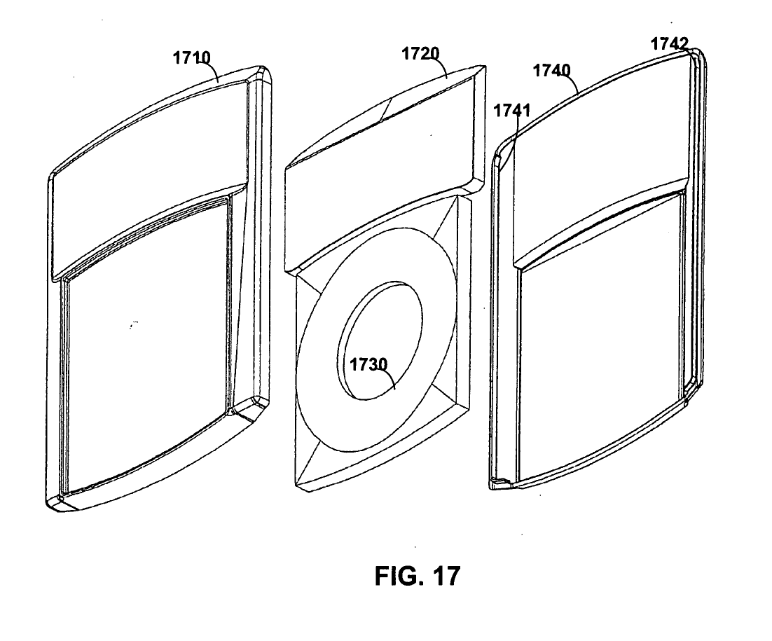

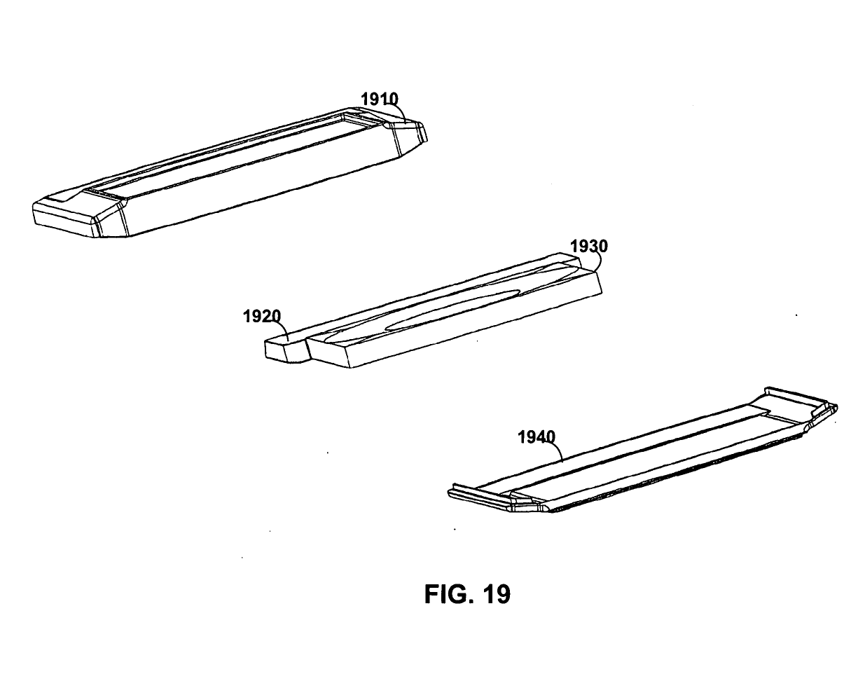

FIGS. 16-19 show slabs 1600, 1700, 1800, and 1900, respectively. Slabs 1600, 1700, 1800, and 1900 show two slab portions that align and mate with each other—sandwiching a collectible between them in the process.

FIG. 16 includes slab portion 1610 and slab portion 1640 that can be removably attached together to sandwich collectible receivable portion 1630 and label support portion 1620 between slab portion 1610 and slab portion 1640. Slab portion 1610 and slab portion 1640 may be permanently bonded together via a bonding process such as an ultrasonic or thermal bonding process. Alternatively, the two slab portions may be, for example, glued together. Slab portions 610 and 1640, when fitted together for example, may define a cavity sized similar to a collectible-receivable portion (e.g., collectible receivable portion 1631) as well as a cavity sized similar to a label support portion (e.g., or another portion). To define such cavity, ridges may be provided on the interior of slab portion 1640 and/or slab portion 1610. Collectible receivable portion 1631 may, for example, include an aperture (or cavity) sized to fit a collectible of a particular size and shape. Thus, multiple collectible receivable portions may be utilized that have the same size and shape, but that have differently shaped collectible-receivable apertures. As such, the collectible holder may be utilized to store and display collectibles of varying shapes and sizes without the need for adjusting the size and shape of the collectible holder (e.g., just the collectible-receivable portion may be changed). A collectible-receivable portion may have an aperture operable to hold, for example, a coin such as a quarter, dime, nickel, penny, half dollar, or dollar coin. Persons skilled in the art will appreciate that any of the features of any slab of the present invention may be utilized with any other slab of the present invention.

The exterior of slab portion 1610 may include a ridge, or a trough, that may be utilized to stack multiple collectible holders formed from slab portions 1610 and 1640. A similarly shaped ridge, or trough, may be provided on the exterior of slab portion 1640. Preferably, these two ridge/trough portions align with one another when slab portions 1610 and 1640 are mechanically coupled together. As per one example, both portions 1610 and 1640 may include similarly shaped ridges (e.g., ridges that extend roughly around the perimeter overlying the cavity operable to house a collectible-receivable portion), but these ridges that extend from the exterior of the slab portions may be slightly different in size such that one ridge fits into another ridge. As such, ridge 1611 on slab portion 1611 of one holder may be stacked (e.g., mechanically mate with) a ridge on a slab portion similar to slab portion 1640 of another holder. As per another example, a slab portion may include a ridge that extends from the exterior surface of the slab portion while the other slab portion may include a trough/cavity that is operable to fit such a ridge. Persons skilled in the art will appreciate that for at least these two examples, the collectible holders can only be stacked in one direction. In other words, the ridges/troughs of two slab portions 1610 may not be operable to be stacked together. Such a configuration assists in making sure that the slabs are all facing the same direction when stacked. As such, a user of a bar code reader, for example, does not have to be concerned with the barcodes being in the same orientation with respect to the reader if the collectible holders are stacked (e.g., and the reader is reading a barcode provided on curved portion 1621 showing through top-curved portion 1641 of slab portion 1640.

Label support 1620 may include, or may not include, an aperture operable to receive an RFID (e.g., an aperture with a depth approximately equal to the thickness of a particular RFID). Alternatively, label support 1620 may not include an RFID-receivable aperture. One or more labels may be fixed (e.g., glued) to label support 1620. For example, a label may be provided over substantially all of the front surface of support 1620 as well as the top of support 1620 (e.g., the area defined by curve 1621). A second label may be provided over substantially all of the rear surface (e.g., shown as having an RFID-receivable aperture) of the label support. A hologram may be fixed to the label provided on the rear of support 1620. Some of the information about the collectible housed in the collectible holder may be provided twice on the label that is provided over the front and top of support 1620. For example, the name of the coin and the grade of the coin may be provided both on the portion of the label extending over the top of the support as well as the portion of the label extending over the front of the support. In this manner, a user can determine the type of collectible (e.g., coin) when the holder is facing the user as well as when the holder is stacked (e.g., stacked in holder rack 1550 of FIG. 15).

Slab portion 1640, which may be the slab portion defining the front of the slab/collectible holder (as compared to slab portion 1610 which may be the slab portion defining the rear of the slab/collectible holder) may include ridge 1642 extending from the interior of slab portion 1640. Ridge 1642 may be a common ridge that defined both the cavity for receiving a label support portion (e.g., the bottom of the cavity) as well as a cavity for receiving a collectible-receivable portion (e.g. the top of the cavity). Ridge 1642 may be curved and bottom 1622 of support portion 1620 and the top of portion 1630 may be curved similar to ridge 1642. Bottom portion 1631 of collectible-receivable portion 1630 may be outwardly curved and shaped similar to the top portion of collectible-receivable portion 1630, which also may be outwardly curved. The sides of collectible-receivable portion 1630 may not be curved (or may be curved). Similarly, supports (e.g., ridges) may be provided in the interior of slab portion 1640 that are shaped similar to the side portions of portion 1630. For example, support 1643 may be the same length as side portion 1632. The height of the support/ridges defining a cavity may also be similar to the thickness of portions 1620 and/or 1630. The inclusion of a ridge as a support may be beneficial as open space 1648 may be provided in a slab instead of filled space (e.g., space 1648 filled with the material used to fabricate a slab portions). Such open space saves resources to create a slab—thus being environmentally friendly and decreasing the cost of the slab to fabricate. Side wall 1645 may be provided to support side 1623 of portion 1620.

FIG. 1700 shows slab configuration 1700 that may include slab portion 1710 (e.g., a front slab portion, label portion 1720, collectible-receivable portion 1730 and slab portion 1750 (e.g., a rear slab portion). Slab portion 1740 may include ridges 1741 and 1742 that may span the length of each side of portion 1740 near the edge of the side and may extend from the interior of slab portion 1741. Such ridges 1741 and 1742 may mechanically couple with the opening provided by slab portion 1710 and the perimeters of both slab portions 1710 and 1740 may be ultrasonically bonded after slab portions 1710 and 1740 are mechanically coupled together (e.g., after ridges 1741 and 1742 fit into, and abut, the interior of the side walls of portion 1710). Ridges 1741 and 1742 may, for example, also extend around the bottom corners of the slab as well as span a portion (or all of so that one ridge is provied) of the bottom of the slab. Alternatively, ridges 1741 and 1742 may extend around the top corners of the slab as well as span a portion of (or all of so that one ridge is provided) the top of the slab. Similarly a ridge may extend around the entire perimeter of the interior of slab portion 1740.

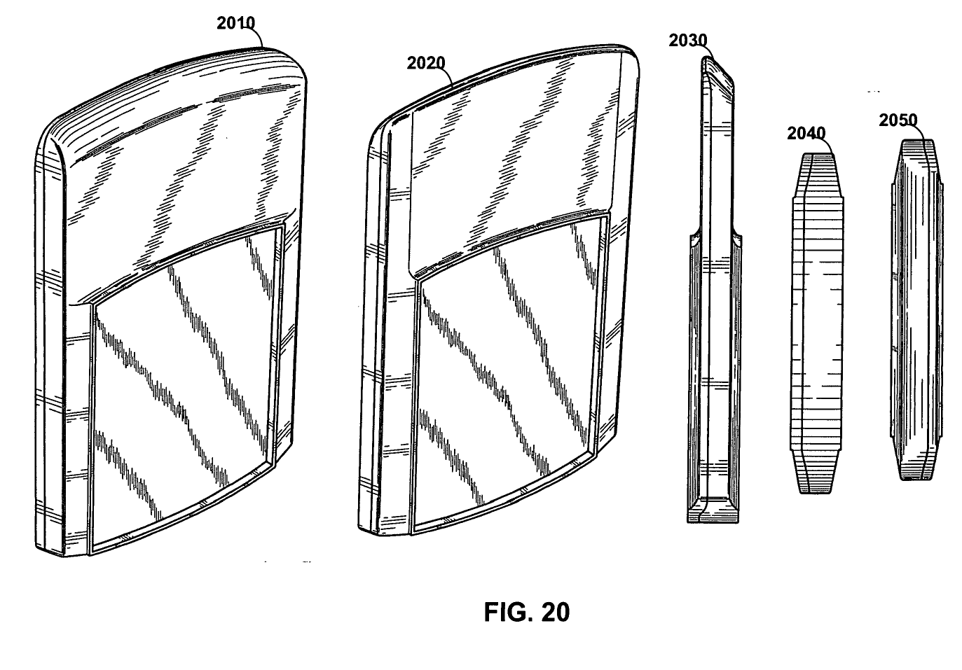

FIGS. 20-23 show slabs 2000, 2100, 2200, and 2300, respectively. Slabs 2000, 2100, 2200, and 2300 show two slab portions that align and mate with each other—sandwiching a collectible between them in the process.

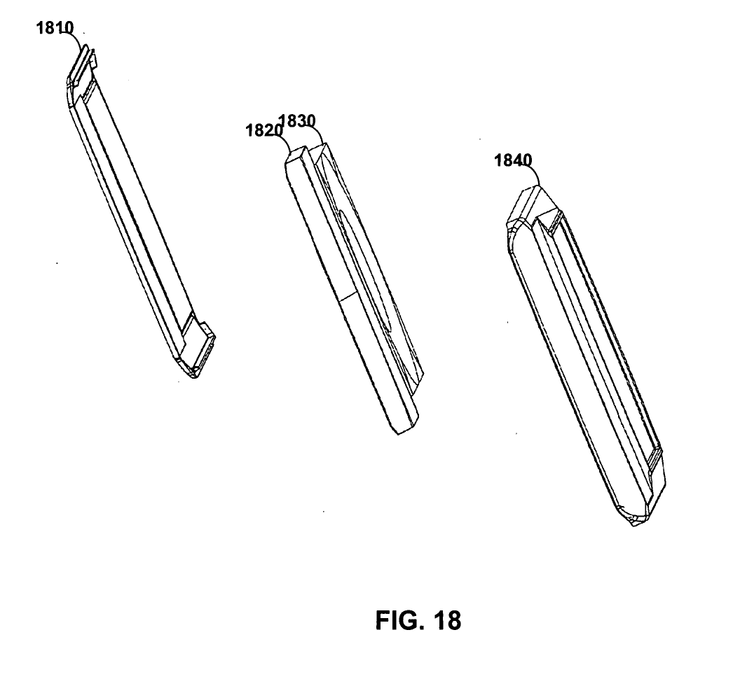

FIG. 18 shows slab configuration 1800 that may include slab portion 1810, label portion 1820, collectible-receivable portion 1830, as well as slab portion 1840. FIG. 18 shows slab configuration 1900 that may include slab portion 1910, label portion 1920, collectible-receivable portion 1930, as well as slab portion 1940.

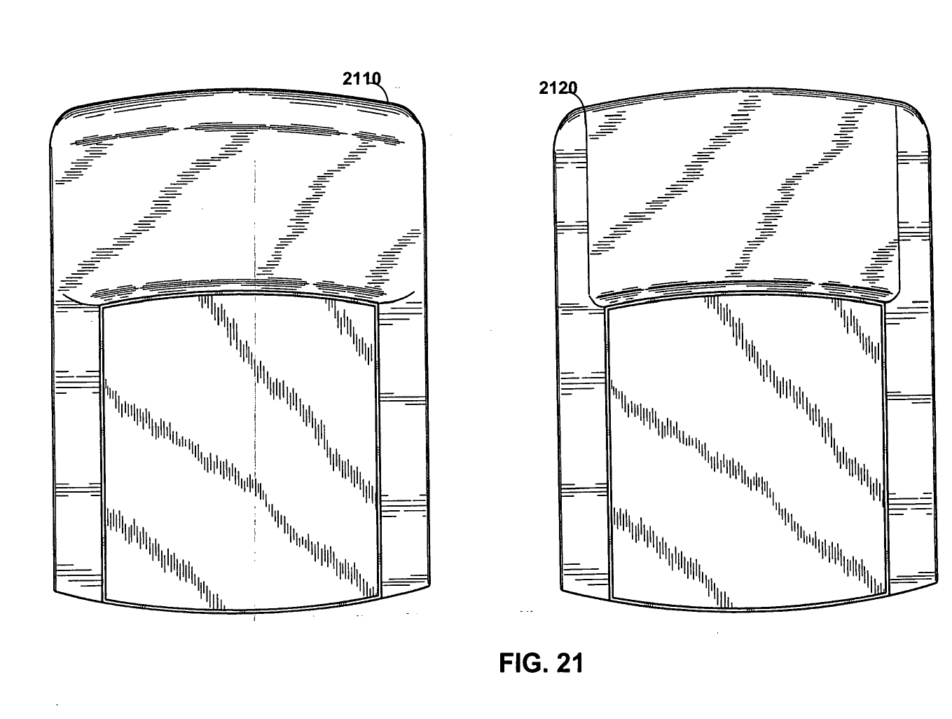

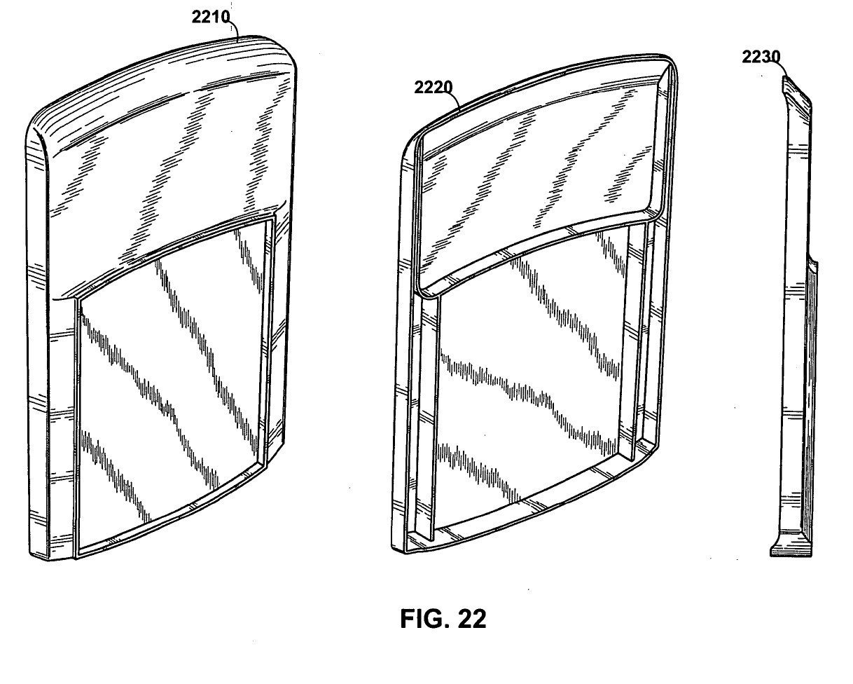

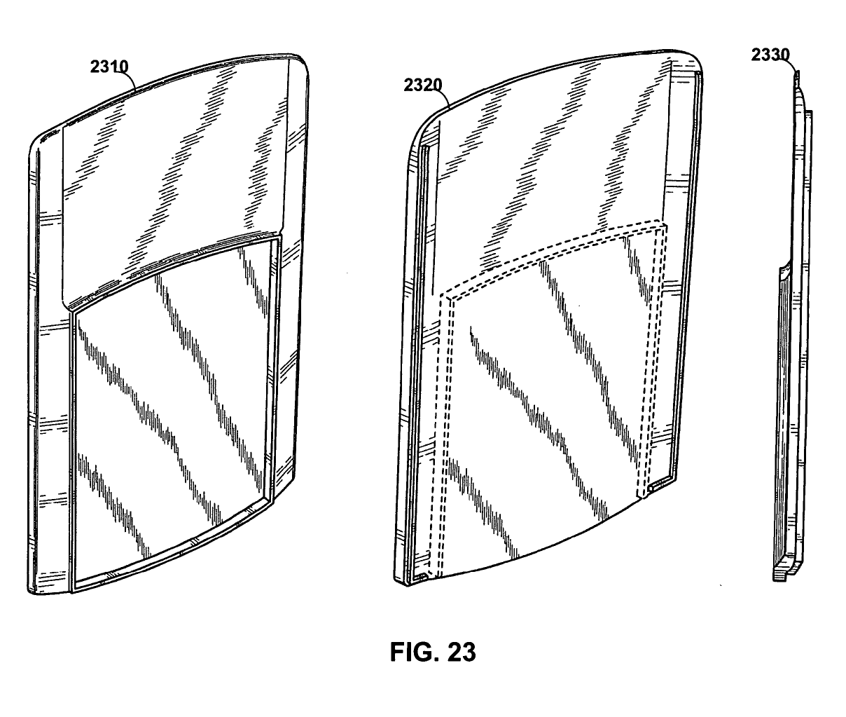

FIG. 20 shows slab perspectives 2000 that may include front perspective 2010, rear perspective 2020, side perspective 2030, bottom perspective 1740, and top perspective 2050. FIG. 21 shows slab perspectives 2100 that may include front perspective 2110 and rear perspective 2120. FIG. 22 shows front slab portion perspectives 2200 that may include, for example, front/exterior perspective 2210, rear/interior perspective 2220, and side perspective 2230. FIG. 23 shows rear slab portion perspectives 2300 that may include front/exterior perspective 2310, rear/interior perspectives 2320, and side perspective 2330. The interior of slab portion 2320 may include, for example, ridge 2321 that extends from the interior of slab portion 2320 and that is sized similar to a collectible-receivable portion and aligned with the collectible-receivable portion cavity of another slab portion. As such, ridge 2321 may provide additional structural support. A ridge may also be provided that extends from the interior of portion 2320 that assists in providing support to a label support portion provided in a slab.

A coin holder, or any other collectible slab, may be sized to be, for example, equal to or less than approximately ⅜ths of an inch thick (e.g., approximately 11/32nds of an inch or approximately 10/32nds of an inch), approximately 3 and ¼ inch tall, and approximately 2 and ⅜ths of an inch wide. Such small sizes may allow for a large number of coin holders to be stored in a particular coin rack. Such small sizes may also allow for a coin holder to be fabricated with less resources (e.g., plastic/acrylic) and, as such, may be more environmentally friendly and inexpensive than larger coin holders.

From the foregoing description, persons skilled in the art will recognize that this invention provides a protection device for collectibles. In addition, persons skilled in the art will appreciate that the various configurations described herein may be combined without departing from the present invention. It will also be recognized that the invention may take many forms other than those disclosed in this specification. Accordingly, it is emphasized that the invention is not limited to the disclosed methods, systems and apparatuses, but is intended to include variations to and modifications thereof which are within the spirit of the following claims.

What is claimed is:

1. A holder for storing a collectible comprising:
a sleeve portion, wherein said sleeve portion is fabricated from a rigid material;
an insert portion having a first aperture, wherein said insert portion is operable to substantially fit into said sleeve portion; and
a collectible receivable portion having a second aperture, wherein said collectible receivable portion is able to be inserted into said first aperture and said second aperture is operable to receive said collectible.

2. The holder of claim 1, wherein said collectible receivable portion is inserted into said insert portion and said insert portion and said sleeve portion are ultrasonically bonded together.

3. The holder of claim 2, wherein an RFID is provided in said ultrasonically bonded holder.

4. The holder of claim 3, wherein said RFID is provided in an aperture, or trough, of said insert portion.

5. The holder of claim 3, wherein said RFID comprises information about said collectible.

6. A holder for storing a collectible comprising:
a first slab portion ultrasonically bonded to a second slab portion, wherein space is defined by said first and second slab portions to hold said collectible; and
an RFID provided between said bonded first and second slab portions, wherein said RFID stores information about said collectible.

7. A holder for storing a collectible comprising:
a first slab portion;
a second slab portion coupled to said first slab portion, wherein a first cavity and a second cavity are defined in said coupled first and second slab portions;
a first member provided in said first cavity, wherein a label is fixed to said member and said label includes information related to said collectible; and
a second member provided in said second cavity, wherein said second member includes an aperture sized to receive said collectible.

8. The holder of claim 7, wherein said first member includes a cavity having an RFID tag provided therein.

9. The holder of claim 7, wherein said first and second slab portions are fabricated from a transparent polymer.

10. The holder of claim 7, wherein said first and second slab portions are ultrasonically bonded together.

11. The holder of claim 7, wherein said label is affixed to the front of, and top of, said first member.

12. The holder of claim 7, wherein said label is affixed to the front of, and top of, said first member and said label includes pre-printed information of the name of said collectible and the grade of said collectible.

13. The holder of claim 7, wherein a second label is affixed to the back of said first member.

14. The holder of claim 7, wherein a second label is affixed to the back of said first member and a hologram is affixed to said second label.

15. The holder of claim 7, wherein said label is affixed to the front of, and top of, said first member, said label includes first pre-printed information of the name of said collectible and the grade of said collectible, said first pre-preprinted information is aligned with the top of said first member, second pre-preprinted information of the name of said collectible and the grade of said collectible is provided on said label, said second information is aligned with the front of said first member.

16. The holder of claim 7, wherein said first member includes an aperture and a RFID inside of said aperture and information representative of the name and grade of said collectible is stored in said RFID.

17. The holder of claim 7, wherein said label is affixed to the front of, and top of, said first member, said label includes first pre-printed information of the name of said collectible and the grade of said collectible, said first pre-preprinted information is aligned with the top of said first member, second pre-preprinted information of the name of said collectible and the grade of said collectible is provided on said label, said second information is aligned with the front of said first member, and an RFID is provided on said first member.

18. The holder of claim 7, wherein said collectible is a coin.

19. The holder of claim 7, wherein said first and second slab portions are ultrasonically bonded together to form a slab, an RFID is provided in said slab, information related to said collectible is stored in said RFID, and said information is available to be accessed through an internet.

20. The holder of claim 7, wherein said first and second slab portions are ultrasonically bonded together to form a slab, an RFID is provided in said slab, information related to said collectible is stored in said RFID, said information includes a grade provided by a grading service, and said information is stored on a remote server accessible by said grading service.

21. The holder of claim 7, wherein said first and second slab portions are ultrasonically bonded together to form a slab, an RFID is provided in said slab, information related to said collectible is stored in said RFID, said information is uploaded by an RFID reader at a convention to provide a list of collectibles present at said convention.

22. The holder of claim 7, wherein said first and second slab portions are ultrasonically bonded together to form a slab, an RFID is provided in said slab, information related to said collectible is stored in said RFID, said information is uploaded by an RFID reader at a convention to provide a list of collectibles present at said convention, and said list of collectibles is provided on a website.

23. A rack for holding a plurality of collectible holders having the same dimensions comprising:
a plurality of ridges extending from the interior surface of said rack for standing the plurality of holders upright, wherein said rack holds approximately twenty-five collectible holders, said rack is approximately three inches wide, said rack is approximately four inches tall, and said rack is approximately nine inches in length.

24. The rack of claim 23, wherein said rack is 8 and 15/16 inches in length.

25. The rack of claim 23, wherein said rack is 2 and ⅝ inches in width.

26. The rack of claim 23, wherein said rack is 3 and ⅞ inches tall.
